(19) United States
(12) Patent Application Publication
(10) Pub. No.: US 2006/0107313 A1
(43) Pub. Date: May 18, 2006

(54) Method, system, and medium for the analysis of information system security

(75) Inventors: John Joseph Crowley, Rockville, MD (US); Jerry A. Dowless, Herndon, VA (US); James E. Ellis, Arlington, VA (US)

Correspondence Address: CASTELLANO MALM FERRARIO & BUCK PLLC, 2121 K STREET, NW, SUITE 800, WASHINGTON, DC, 20037, US

(73) Assignee: Dowless & Associates

(21) Appl. No.: 10/986,070

(22) Filed: Nov. 12, 2004

(51) Int. Cl. H04L 9/32

(52) U.S. Cl. 726/6

(57) ABSTRACT

A method, system, and medium for performing a security analysis of a system, which is comprised of components and paths wherein a user identifies the components and paths of a system, associates a set of predetermined requirements to the components and paths of a system, and wherein the user selects security services to satisfy the requirements of the paths and components of the system. In at least some embodiments of the invention, the method comprises the publication of reports detailing the components, paths, requirements, and security services of a system as well as the rationale that a security service satisfies the requirements mapped to the components and paths of the system.

### FIELD OF THE INVENTION

The present invention relates generally to the field of security analysis, review, reporting, and management and, more particularly, to a computer system method and medium that enables users to design, build, evaluate, manage, and document a system's security fitness.

### BACKGROUND DESCRIPTION

Security analysis, reporting, and management are important aspects to enterprise infrastructure. The U.S. Government is leading the move to secure its enterprise infrastructure by developing specific requirements to ensure that systems are securely developed and properly implemented. Currently, there are few tools available to accomplish the task of security analysis, reporting, and management.

The government has established a system certification and accreditation (C&A) process for their deployed infrastructure whereby systems to be employed within their infrastructure are required to undergo a thorough security review. The design, development, and deployment of adequately secured systems that mitigate threats and identify residual risk is the C&A process objective; thereby enabling the Designated Approving Authority (DAA) to make informed decisions about the deployment of systems within the enterprise. Certification is the process by which a comprehensive review of the system infrastructure is evaluated against a set of security requirements. Certification requirements, can for example, be found or be made in accordance with Department of Defense (DoD) Instruction 5200.40, dated Dec. 30, 1997, entitled DoD Information Technology Security Certification and Accreditation Process (DITSCAP), which is incorporated herein by reference in its entirety. Accreditation is the formal declaration by a DAA that the system infrastructure meets the selected security requirements.

Other enterprises have similarly implemented security policies to safeguard business and/or customer data. The importance of secure networks spans the public and private sectors and includes financial institutions, the intelligence community, the pharmaceutical industry, the legal profession, public utilities, etc. Specific and sometimes statutorily mandated privacy and/or security policies, such as the Health Insurance Portability and Accountability Act of 1996 (“HIPAA”) in the medical field, have been developed for businesses. Business, vendors, service providers, and others must implement and design information systems that meet or exceed the minimum standards developed for a particular field.

All enterprises are primarily concerned with meeting the mission requirements of the enterprise. Core business operations generally determine the bulk of systems developed and deployed in the environment. Enterprises typically do not have adequate standards developed and effectively distributed to influence and guide the system build processes. This inadequacy is particularly true where strict system security measures are necessary. For example, few enterprises have strictly controlled and designed products from which developers may select to build, design, and analyze their systems. These enterprises do not have effective tools to review and evaluate their products for implementation fitness and overall security worthiness, nor have enterprises developed guidelines to ensure proper implementation. As a result, systems are often developed and deployed with serious security vulnerabilities, which are capable of compromising system integrity thus leaving the enterprise at risk. Moreover, said shortfalls may lead to the introduction of the same vulnerabilities into other enterprise environments, creating a domino effect of potential security lapses and shortfalls.

System security assessments typically take the form of a written System Security Plan (SSP). System Security Plans are often required to document system security. The development and documentation of an SSP can be time consuming and tedious, inconsistencies between projects often exist, and they are often incomplete or lack comprehensive security analysis. The enterprise security stakeholders may review SSPs to determine whether the implementers have satisfied security requirements. However, accurately determining whether security measures have met minimum protection requirements may be difficult. In addition, as systems change over time, a need exists to ensure that systems continue to meet the specified requirements. With respect to government security mandates, when significant components of the system have changed (i.e., the operating system), the system's certification must be updated and reaccredidation is usually required. Similarly, new regulations or standards may be developed after the design and implementation of a system. Accordingly, system operators and/or consultants may need to re-evaluate a system to determine whether the system complies with the newly adopted security standards.

To manage enterprise security, and more particularly, manage enterprise security through the C&A process, typically a number of different security measures are used. A comprehensive enterprise security management system would contain many, if not all, of the following features: industry best practices (IBP), organizational security standards, system security documentation, review and assessment, and security configuration management.

Accordingly, a need exists for tools, methods, and processes by which enterprise developers are provided products and services of known security integrity in order to design and evaluate system security. This need requires flexible products to implement secure network infrastructures capable of meeting the dynamics of system threats and vulnerabilities. Additionally, a need exists for tools, methods, and processes to reduce the effort necessary to comply with system security requirements, streamline the C&A process, and improve security management and risk assessment.

### SUMMARY OF THE INVENTION

The present invention relates to methods, systems, and devices to aid in the design, build, evaluation, and implementation of secure systems. The method comprises collecting information about the system to be designed or reviewed, identifying the components and paths between the components of the system, identifying the security services used on each of the components, selecting requirements to apply to the identified components and paths, and determining the interaction of the security systems with every other component and/or path.

In one embodiment of the present invention, the method includes a step of providing a report, wherein a rationale is provided for the determination that the security services selected satisfy the requirements associated to the components and/or paths of a system.

In another embodiment of the present invention, the method includes a step providing a report detailing the security analysis of a system.

Another embodiment of the invention relates to a first computer system for performing a security analysis of a second computer system. In another embodiment, the present invention relates to a software program for performing a system security analysis.

### BRIEF DESCRIPTION OF THE DRAWINGS

The Detailed Description will be best understood when read in reference to the accompanying figures wherein:

FIG. 1 is an exemplary high level diagram that provides an overview of the interrelationship between the security policy and components and paths of a system;

FIG. 2 is a high level workflow diagram that shows a method contemplated by one or more embodiments of the present invention;

FIG. 3 is an exemplary flow diagram that shows a method contemplated by at least one of the embodiments of the present invention by which a user may map requirements to components;

FIG. 4 is an exemplary flow diagram that shows a method contemplated by at least one of the embodiments of the present invention by which a user may map requirements to paths;

FIG. 5 is an exemplary flow diagram that shows a method contemplated by at least one of the embodiments of the present invention by which a user may map security services to components and paths;

FIG. 6 is an exemplary screen display showing component compliance with the selected requirement;

FIG. 7 is an exemplary screen display showing the components of a system and the security services mapped thereto;

FIG. 8 is an exemplary screen display showing path compliance with the selected requirements;

FIG. 9 is an exemplary screen display showing security services and the components mapped thereto;

FIG. 10 is an exemplary screen display showing a system object inventory tree;

FIG. 11 is an exemplary architecture of a basic system contemplated by at least some embodiments of the present invention;

FIG. 12 is an exemplary screen display showing how a user can create, edit, remove and component or component group.

FIG. 13 is an exemplary screen display showing how a user may create a component group and select a component group type.

FIG. 14 is an exemplary screen display showing how a user may create, edit, or remove a path.

FIG. 15 is an exemplary screen display showing how a user may create a new path and select a new path type.

FIG. 16 is an exemplary screen display showing how a user may create, edit, or remove a security service.

FIG. 17 is an exemplary screen display showing how a user may view protection levels/levels of concern and manage a ConOp document and ConOp diagram.

FIG. 18 is a high level flow chart showing the relationship between one component mapped to one security service and requirements mapped to the component.

### DETAILED DESCRIPTION OF THE INVENTION

The preferred embodiments of the invention will now be described with reference to the attached drawing figures. The following detailed description of the invention is not intended to be illustrative of all embodiments. In describing exemplary embodiments of the present invention, specific terminology is employed for the sake of clarity. However, the invention is not intended to be limited to the specific terminology so selected. It is to be understood that each specific element includes all technical equivalents that operate in a similar manner to accomplish a similar purpose.

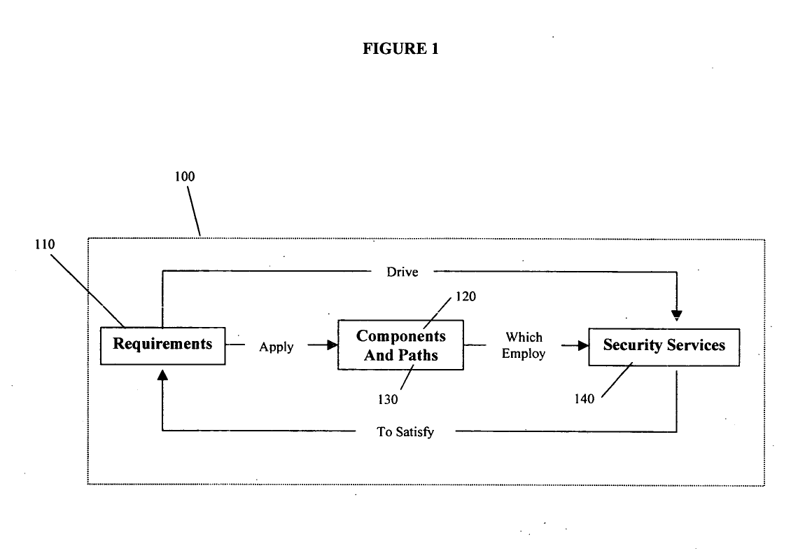

With reference to FIG. 1, a high level diagram is shown that provides an overview of the interrelationship in a system 100 between the security policy of a system and its components according to one or more embodiments of the present invention. As used herein, a system refers to a collection of hardware and software components arranged, configured, or interconnected via paths that allow for the transfer of data or information between said hardware and software components. With respect to the present invention, one of ordinary skill in the art would understand that a system may be comprised of either components or component groups, either singularly, or in combination. The embodiments described herein contemplate a system that may include one or the other or both in combination.

As used herein, a security policy refers to the minimum level of standards a overall system must meet. A security policy often includes specific requirements and/or parameters.

As used herein, a requirement is the minimum level of security necessary to protect a component, path, or system from a security risk. An organization, government, user, client, or any other entity may specify requirements. Requirements are often, but not always, part of a broader security policy that may be set by an individual user, organization, consultant, project manager or any other entity, governmental or nongovernmental. Examples of security policies that are comprised of requirements include, but are not limited to, DCID 6/3, DoD DITSCAP, NIACAP, HIPAA, and or BS/ISO requirements.

As used herein, a component can be anything in an information system that could potentially have a requirement mapped to it or that could contain potential security risks. Examples of components include, but are not limited to, a server, a workstation, a router, and an operating system. A component group is an entity in an information system that is a logical grouping of several components. For example, a file server may be comprised of several components such as an operating system, files, email, etc.

As used herein, mapping refers to the association of one entity to another.

As used herein, a path is any logical or physical connection that could potentially have requirements mapped to it or could contain potential security risks. An example of a path includes, but is not limited to, a file transfer between a client personal computer and the file server.

As used herein, a security risk is any circumstance or event that potentially may damage a system by, for example, the dissemination, disclosure, unauthorized download or copying, destruction, deletion, modification of data or system resources or any other action with adverse consequences to a system. A specific example of a security risk includes, but is not limited to, the interception of data during file transfer. Another example of a security risk is a denial of service attack.

As used herein, security service is anything in an information system that could be used to satisfy requirements or mitigate a security risk. Security services may include, but are not limited to, firewalls, login applications, access control applications, encryption applications, including but not limited to Public Key Infrastructure (“PKI”) and Secure Sockets Layer (“SSL”), and other applications, codes, script, methods, strategies, or processes of protecting the system from a security risk. A security service may also include human action, such as physical inspection, routine maintenance, etc.

FIG. 1 shows the relationship between security requirements 110, the system components 120, paths through the system 130, and the security services 140 used to protect the system. In general, the requirements 110 of a system 100 will determine the security services 140 selected in that the security services 140 of a system 100 are selected to satisfy the requirements 110. The requirements 110 of a system 100 apply to all components 120 and paths 130 as specified by the security policy. Accordingly, the components 120 and paths 130 of a system 100 may employ security services 140 to satisfy the applied requirements 110. The security services 140 employed by the components 120 and paths 130 may be provided by various products and may be intrinsic or extrinsic to the system. Intrinsic security services are services that reside on or are part of the path or component of a system. Extrinsic security services may be, for example, third party software or firmware that is added to a system to protect the components and paths of a system. As requirements 110 and policy change, the security services 140 employed may also change.

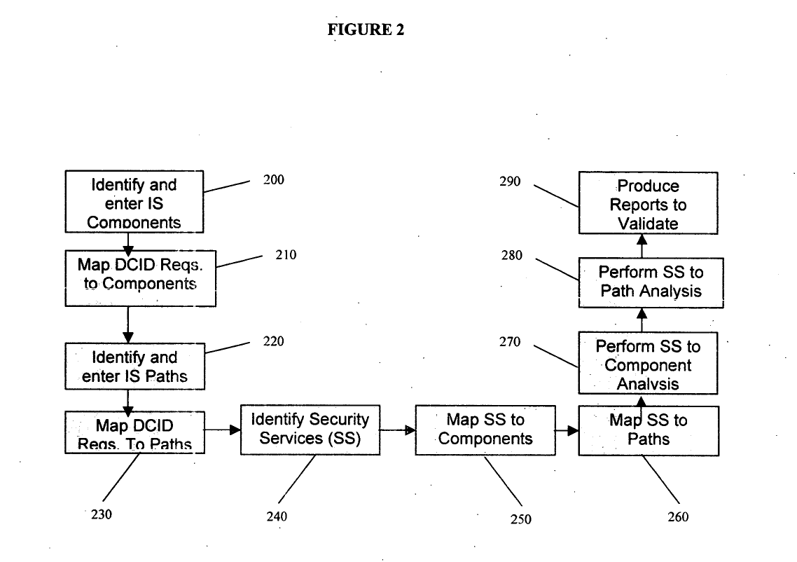

Referring now to FIG. 2, a high-level workflow diagram is provided showing the workflow or method according to one or more embodiments of the present invention. In the first step 200, the components of a system are identified and entered. Once the components of a system have been identified, the requirements are mapped to each component in the next step 210. In the next step 220, the paths of the system are identified. Once the paths of a system have been identified, the requirements are mapped to each path in step 230. In the next step 240, security services of the system to be used are identified. The security services are then mapped to the components of the system in step 250 and are mapped to the paths of the system in step 260. An analysis of the security services mapped to the components is then performed in step 270 to determine whether the security services meet the requirements mapped to the components. In addition, in step 280, an analysis of the security services mapped to the paths of the system is performed to determine whether the security services meet the requirements mapped to the paths. Finally, in step 290, reports are generated to validate, inform, detail, document, identify, and/or record the correlation of security services to requirements mapped to either the components or paths. One of ordinary skill in the art would understand that the order of the steps described could be modified in any way such that the overall objective of correlating or comparing the requirements mapped to the components and paths against the security services assigned to said components or paths is satisfied.

### System Identification and Requirement Selection

As the methods and processes of the present invention may employ a variety of security policies, the user may select any appropriate security policy prior to implementing a security design, build, or review of a system. Typically during the design, build, or testing of a system, an individual may select a particular area of the system to analyze. Whether the entire system as a whole is designed, built, or reviewed or whether a particular part of the system is under review or consideration, the user may designate the whole or part of the system under review or design as a project. As used herein, a project is a system for which a security review is desired.

The security policy may be selected based on a desired security level or may be mandated by an organization, for example, a governmental agency or private entity. Security policies may include regulations, standards, and requirements that are applicable to systems employed in various fields including but not limited to, governmental agencies, health care, the intelligence community, the pharmaceutical industry, banking, and others. The security policy selected will then be designated to the project under design, review, or testing.

At the beginning of any security analysis of a project, a user may identify the security policy to be used and may review the security parameters of said security policy. By way of example, the security policy DCID 6/3 contains protection levels and levels of concern that can be reviewed. For any given project, the specific protection levels and levels of concern may be selected, said actions resulting in the association of certain requirements to particular aspects of the project. Depending on the security policy selected and whether that particular security policy has variable requirements that relate to protection levels or other designations, the security policy may dictate the applicability of requirements to parts of the system. The method contemplates the ability to edit, modify, delete, make additions to, and customize the protection levels and levels of concern for any particular project. The methods of the present invention contemplates the ability to edit, modify, delete, make additions to, and customize the requirements of a security policy for any particular project.

According to at least one embodiment of the present invention, the method contemplates the use of a Concept of Operation (“ConOp”) document and diagram. The ConOp document is any document detailing the design or build of a project. The ConOp diagram is any document that graphically represents the design or build of a project. The method contemplates the design, build, or security review of a system according to, or guided by, the ConOp document and diagram. In this embodiment of the invention, the security policy, component identity and descriptions, path identity and descriptions, security services used, and security policy requirements may, in part or whole, be contained within the ConOp document or diagram. In conjunction with the security policy selected, the ConOp document and/or diagram may provide the user with a starting point from which a security analysis or review is conducted.

### Component, Path, and Requirement Identification and Mapping

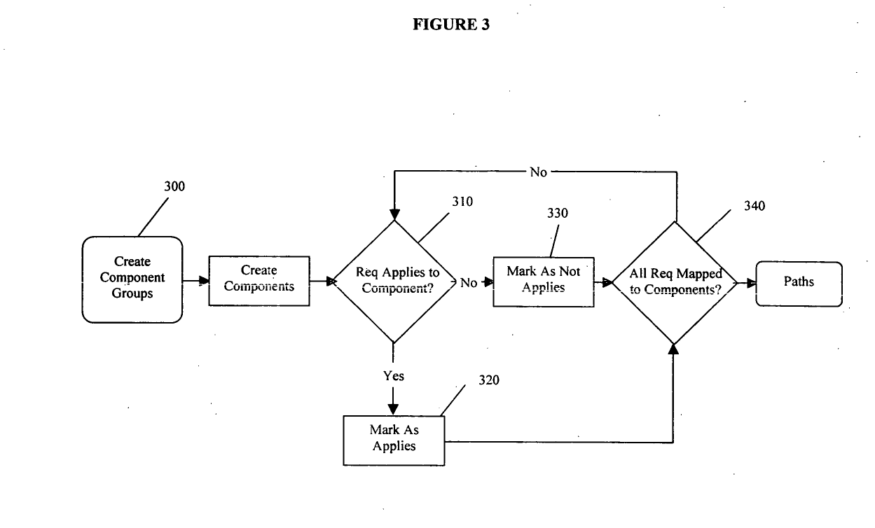

Referring to FIG. 3, a flow diagram is shown indicating the process by which a user may apply requirements of a security policy to the components or the component groups of a system. With reference to FIG. 3, in one embodiment of the present invention, component groups are created and requirements are mapped to the component groups. In the first step 300, the user creates component groups, which are comprised of individual components. For example, a user may create component groups by selecting the components of a system and manually or automatically identifying said components as a part of the system. In the next step 310, the user then determines whether a requirement applies to the selected component groups. If a requirement applies to the component group, the user marks the requirement as applying to the component group in step 320. If the requirement does not apply to the component group, the user marks the requirement as not applicable in step 330. At step 340, the user determines whether all relevant requirements have been mapped to the identified component groups. Once all relevant requirements have been either mapped to the component or marked as not applies, the user may then proceed to the identification of the paths of a system.

In one embodiment of the present invention, a user may identify components as shared components. A shared component is a component that may be part of two or more component groups. Once created, a shared component (and the requirements and security services that apply to the shared component) is documented for the remainder of the security build, design, or review process. This feature reduces the duplicate entry of components, security services, and requirements and further streamlines the process. An example of a shared component may be Windows XP Operating Software. The shared components, in this example, may reside on several servers (i.e., several component groups). By designating Windows XP as a shared component, the component description, requirements and security services mapped thereto will be the same for the Windows XP component for each component group. This example demonstrates the feature of the method which reduces redundant entries and analysis of components that may be used more than once in a project.

In another embodiment of the invention, a user may be limited with respect to creating or editing shared components. In other embodiments, a user may create, modify, and/or edit the shared components as authorized. These features of the invention prevent the misuse of the shared component feature of the invention.

In another embodiment of the invention, a user may select a component type from a customizable and/or predetermined list for any project or system. In this embodiment of the present invention, the method would allow for the automatic association of a requirement(s) based on the selected component type. In addition, the automatic association of requirement(s) to a component based on component type may be modified after the automated association. In this example, the user may then add or remove requirements from the component, whether automatically assigned or not. The association of requirements to components based on the component type designation may relate to the security policy selected for that particular project or may be customized by the user.

In yet another embodiment of the present invention, a user may have a means by which to provide a reason or explanation as to why a particular requirement applies or does not apply to a component or component group. This feature of the methods of the present invention documents the reasoning of the user and may be useful in making future security reviews or may be useful for other purposes that are evident to those skilled in the art.

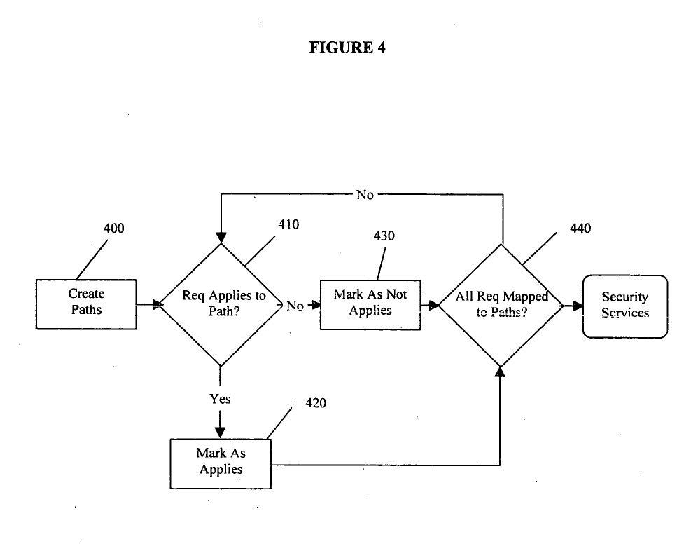

Once the component groups, components, and corresponding requirements are identified, a user may then identify the paths of the system. With reference now to FIG. 4, the user creates or identifies the paths 400 of a system. In a first step 410, the user determines whether the selected requirements apply to the created or identified paths of a system. If the user determines that a requirement applies to a path then the user marks that requirement as applying to the path in the next step 420. If the user determines that the requirement does not apply to a path, then the user marks that requirement as not applying to the path in step 430. The user then determines whether all requirements have been mapped to the paths in step 440.

In one embodiment of the present invention, the user is provided a means by which it may provide additional reasoning why a requirement does or does not apply to a path. This feature of the methods of the present invention documents the reasoning of the user and may be useful in making future security reviews or may be useful for other purposes that are evident to those skilled in the art.

In another embodiment of the present invention, a user may select from a predetermined list a path type for any identified path. In this embodiment of the present invention, the method would allow for the automatic association of a requirement(s) based on the path type. In addition, the automatic association of requirement(s) to a path based on the selected path type may be modified after the automated association. In this example, the user may then add or remove requirements associated with a the path, whether automatically assigned or not. The association of requirements to paths based on the selected path type may be based on the security policy selected for that particular project or may be customized by the user.

### Security Service Identification and Security Review

Once a user has identified all components and paths and mapped requirements thereto, the method contemplates the identification of security services and the analysis thereof.

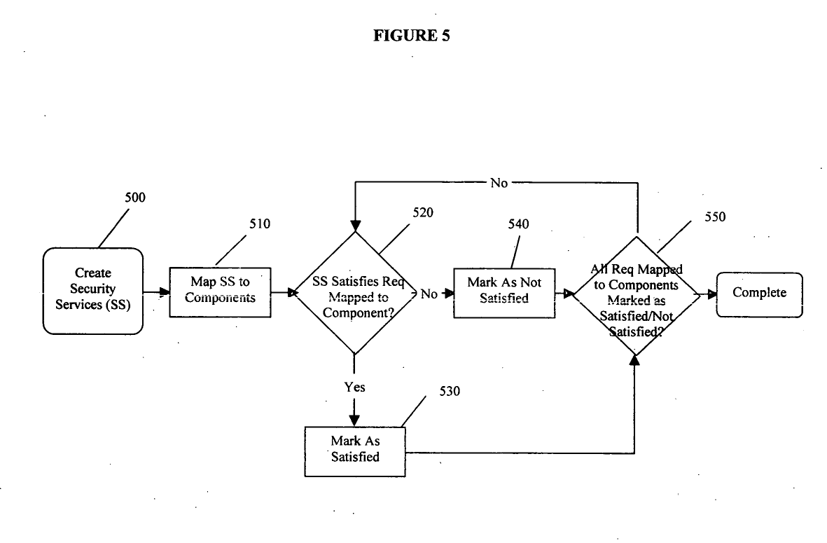

According to at least one embodiment of the present invention, the security services that will protect the identified paths and components of a project will then be identified. With reference to FIG. 5, a user identifies and creates the various security services that will be used to satisfy the selected requirements 500. Once identified, the security service is selected or mapped to protect a component or path in step 510. The user then determines whether the security service mapped to a component or path satisfies the requirement mapped to the component or path in step 520. If the security service mapped to a component or path satisfies the requirement mapped to the component or path, the user marks the requirement satisfied in step 530. If the security service mapped to a component or path does not satisfy the requirement mapped to the component or path, the user marks the requirement as not satisfied in step 540. The user then determines whether all requirements mapped to the components and paths have been satisfied by the selected security services in step 550.

In one embodiment of the present invention, the user may provide a rationale explaining the basis for the determination that the security service satisfies the requirement mapped to a component or path. In another embodiment of the present invention a user may not be able to proceed with any additional step until a rationale for the determination that a security service satisfies a requirement mapped to a component or path is provided.

In another embodiment of the present invention, security services may be designated as satisfying one or more requirements of a security policy. In this embodiment, the method will automatically determine for one or more security services mapped to a component or path whether a requirement mapped to a component or path is satisfied.

### Reporting and Documentation

Once the user has identified the requirements, components, paths, and security services of a system, a report may be generated. A system security analysis report provides the user with information pertaining to the system including whether the security services of a system satisfy the requirements selected. The report may also provide the rationale for the determination that a security service satisfies requirements mapped to the components and/or paths of the system. The system security analysis report is customizable and may provide the user with information about the security of a system in a variety of formats and with respect to different parameters or criteria.

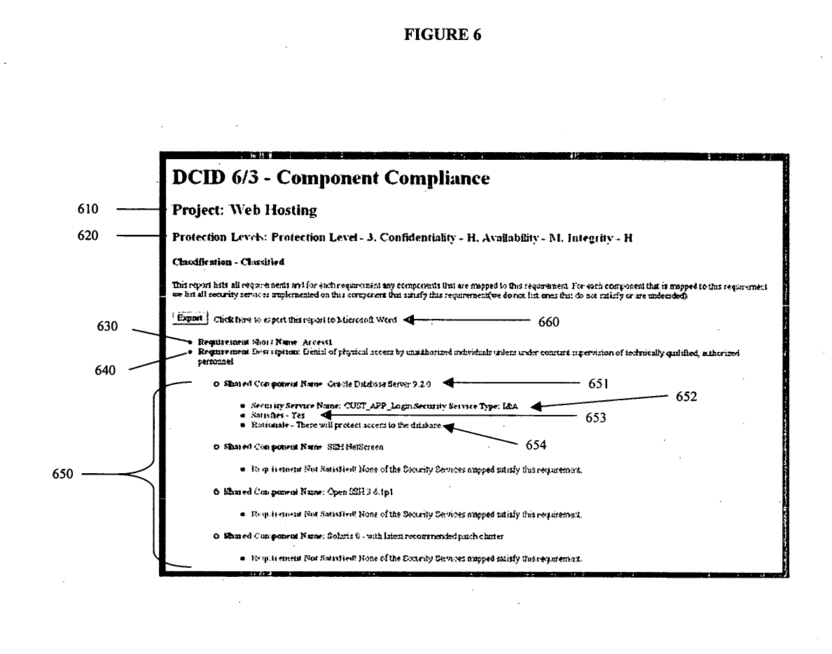

In one embodiment of the present invention, a user may be provided with a report detailing whether any component of the system complies with the selected requirements. By way of example only and with reference to FIG. 6, a report of a system's component compliance with DCID 6/3 requirements is provided.

FIG. 6 is an exemplary screen display of a report informing the user of the component compliance of a system for a particular project 610. As shown in FIG. 6, the report may contain information related to the protection levels 620 associated with a particular project 610. The protection levels 620 are assigned and determined as a function of the security policy selected as described above.

In the present example and with reference to FIG. 6, a report detailing the component compliance for the project 610 “Web Hosting” is provided. The report lists the protection levels 620 associated with the project. The report lists the requirements 630 that are associated with the project 610. The report may also provide a description 640 of the requirement 630 associated with the project 610. As seen in the exemplary screen display, the user is provided with a listing 650 of the components for which the displayed requirement 630 are mapped. The list 650 of components may be comprised of the shared components, component groups, or components that are associated with the listed requirement 630. The report provides the user with the shared component name 651 to which the listed requirement 630 applies. The report also provides the name of the security service 652 that is mapped to the listed component 651. The report provides a field 653 by which the report may indicate whether the security service 652 satisfies the requirement 630 for the listed component 651. The report may also provide a rationale field 654 that provides an explanation for why the security service 652 satisfies the requirement 630 for any given component 651. The present invention also contemplates the ability to export the report as a file to another application. In this example, a field 660 is provided by which a user may export the report to Microsoft Word.

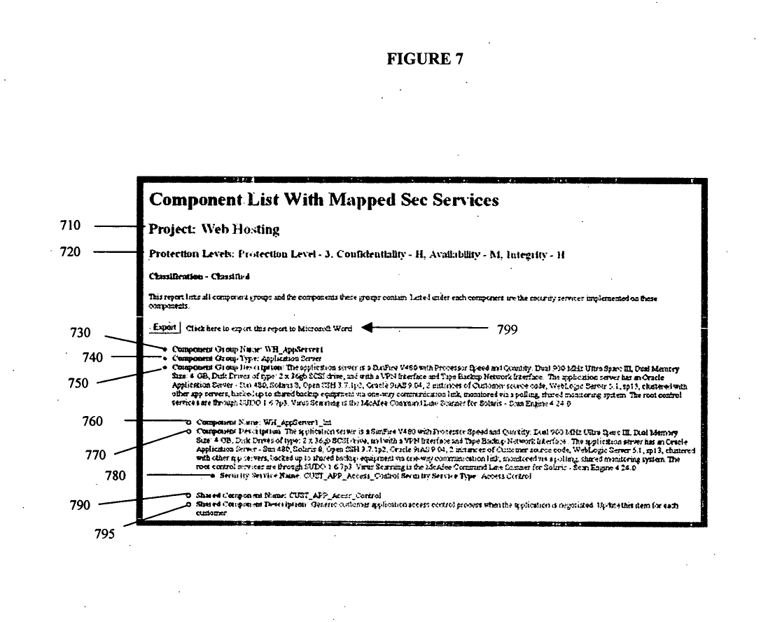

In another embodiment of the present invention, the software may provide a user with a report detailing all of the component groups and the components within those groups and all of the security services mapped to said components. By way of example and with reference to FIG. 7, an exemplary screen display of a report showing a list of components and the security services mapped thereto is provided. FIG. 7 is an exemplary screen display of a report informing the user of the various components of a system and security services associated with said components. As seen in FIG. 7, a report detailing the components and the security services mapped thereto for a particular project may be displayed. The report provides the user with information relating to the particular project 710 selected and the protection levels associated with said project 720. The report provides the user with the component group name 730 associated with the project 710, the component group type 740, and a component group description 750. The report provides the user with the components 760 and component description 770 of the component group 730. The report lists the security service(s) 780 associated with any particular component 760. The report may also list the shared components 790 of a project 710 and shared component description 795. The present invention also contemplates the ability to export the report as a file to another application. In this example, a field 799 is provided by which a user may export the report to Microsoft Word.

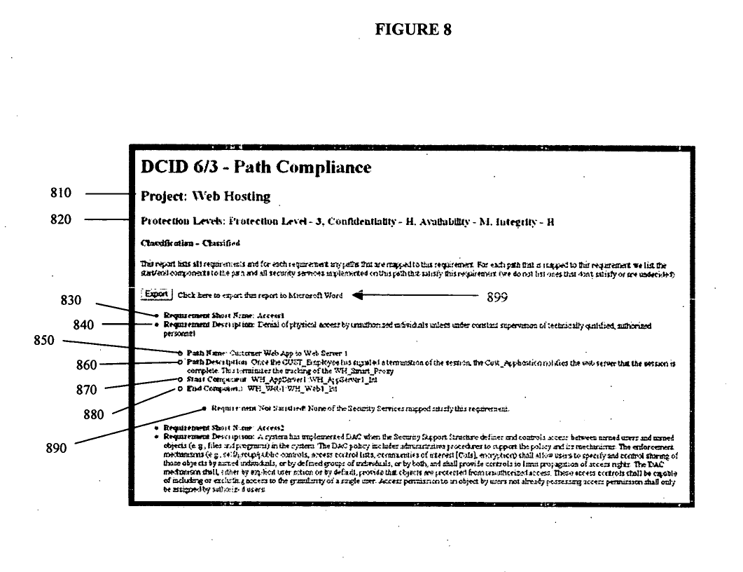

In another embodiment of the present invention, the software may provide a user with a report detailing the path compliance of a system to a set of requirements. By way of example and with reference to FIG. 8, an exemplary screen display of a path list with and its compliance to a set of requirements, more particularly DCID 6/3 requirements, is provided. As shown in FIG. 8, the report contains information related to a project 810 of a system. The protection levels 820 associated with a particular project 810 are displayed. The protection levels 820 are assigned and determined as a function of the security policy selected as described herein. As seen in FIG. 8, the report lists all requirements 830 and provides a description of the requirements 840. The report lists the path name 850 and path description 860 for all paths to which the listed requirement 830 has been mapped. The report also provides the start component 860 and end component 870 for the listed path 850. The report also lists all security services implemented on the listed path 850 and whether the requirement satisfies 890 the listed requirement 830. The present invention also contemplates the ability to export the report as a file to another application. In this example, a field 899 is provided by which a user may export the report to Microsoft Word.

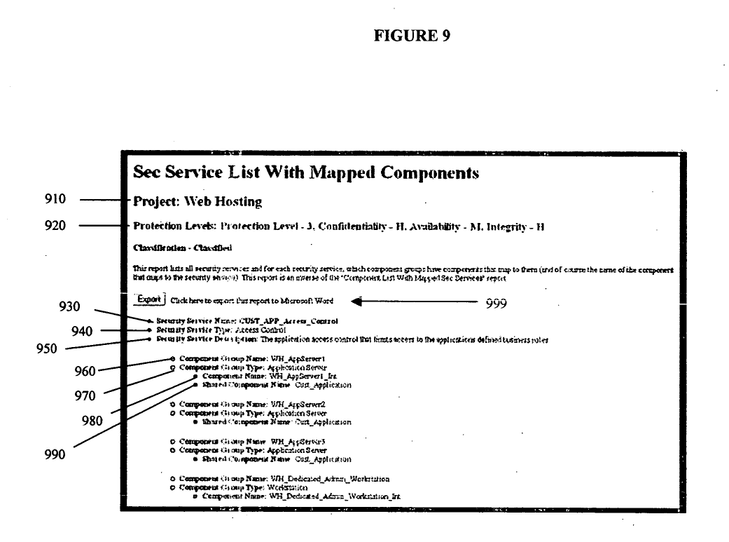

In another embodiment of the present invention, the software may provide a user with a report detailing the security services mapped to the system's components. By way of example and with reference to FIG. 9, an exemplary screen display of a security service list and their corresponding components is provided. As shown in FIG. 9, the report contains information related to a project 910 of a system. The protection levels 920 associated with a particular project 910 are displayed. The protection levels 920 are assigned and determined as a function of the security policy selected as described herein. FIG. 9 is an exemplary screen display of a report informing the user of a project's 910 security services 930 and the components associated with said security services 910. As seen in FIG. 9, the report lists all security services 930 associated with a project 910. The report lists the security service name 930, security service type 940, and security service description 950. The report then lists the component group name 960 associated with the listed security service 930. The report also contains the component group type 970, the component name 980, and the shared component name 990. The present invention also contemplates the ability to export the report as a file to another application. In this example, a field 999 is provided by which a user may export the report to Microsoft Word.

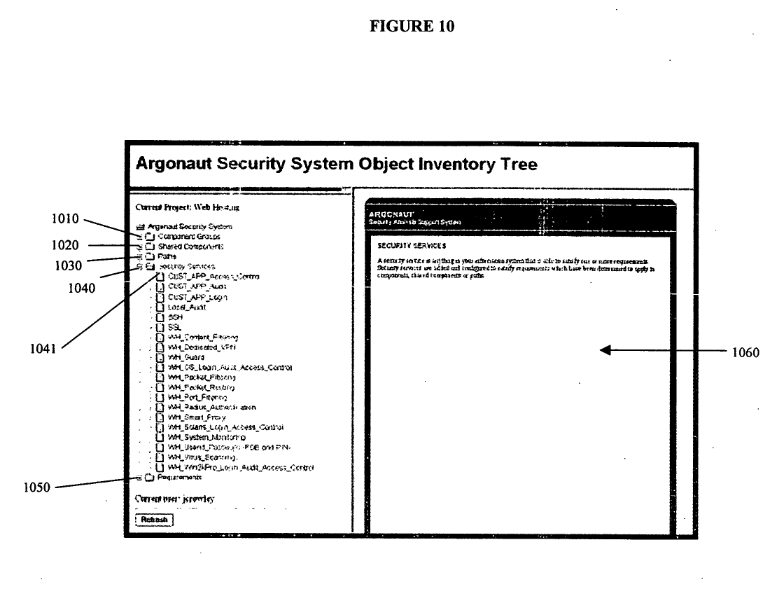

In another embodiment of the present invention, the software may provide a user with a screen that lists all of the system's components, paths, security services, and requirements in a tree-like format. By way of example and with reference to FIG. 10, an exemplary screen display of a system's information in a tree-like format for the project “Web Hosting” 1000 is provided. As shown in FIG. 10, the screen displays folders corresponding to a system's component groups 1010, shared components 1020, paths 1030, security services 1040, and requirements 1050. The software may also provide the user with a list of the components, shared components, paths, security services, and requirements. With reference to FIG. 10, the screen display may show a list of security services 1040 that includes security service “CUST_APP_Access_Control” 1041. The list of security services 1040 presented in FIG. 10 are those that are mapped for a given project 1000. The screen window 1060 displays information related to the selected component group, shared component, paths, security services, or requirements. It is contemplated that the screen may also display a list of the various paths, components, and requirements.

In another embodiment of the present invention, the method would document any and all changes, inputs, designations, mappings, identified components, paths, requirements, or services for any particular project. The method could also track any and all changes to any of the parameters mentioned above including but not limited to any additions or deletions to a project's components, paths, requirements, security services, or rationales. In this embodiment, the method provides a means by which a user may react to or address the design, build, or security implications that any changes to a project may entail making the security analysis and review an easier and less time consuming task. It is contemplated that the method would allow for the documentation or preservation of a project's parameters in paper or electronic form. It is further contemplated that any changes made to the parameters of the project may be stored, recorded, communicated, identified, or otherwise reported at any time by any number of means known to those skilled in the art.

In yet another embodiment of the present invention, the method would allow for the contingent approval of a security analysis in the case that a requirement may not be fully satisfied by a mapped security service. Such a situation may occur where, for instance, no known security services fully or partially satisfy a given requirement or where a requirement has changed such that existing security services no longer satisfy the requirement. This situation is known as mitigations strategies. In the case that a project has a mitigation strategy employed, it is contemplated that the method would allow for the identification of any and all parts of a project or system subject to mitigation strategies. The method contemplates means by which a user is informed of all or part of the unmet requirements of a project such that the user may update the relevant security service for the components and paths to which the requirement applies. Similarly, the method would allow for the documentation and identification of any paths or components whose requirements may not be fully met so that known vulnerabilities may be tracked or reviewed.

### Example of Method on Theoretical System

The following is a description of one or more embodiments of the present invention as they apply to a theoretical information system. In one embodiment of the present invention, a computer will have stored thereon or have access to a repository (e.g. a database) of security policies and their associated requirements from various organizations, entities, or individuals. The computer and the information stored or data accessible by it may have an administrator account created by the software stored on a computer or a computer readable medium. The administrator is provided a method of logging into the system, which may be comprised of a username and password. Additional means by which an administrator may log into the system may be provided. To begin the process, the administrator may log into the system and create a project. The project may be named and additional users accounts may be created. The additional user accounts may, for example, be created for two employees of an organization, or an employee of an organization and a security consultant, or any other combination of individuals to which access to the system is desired. In the present example, the administrator creates two user accounts for the project. By way of example, the administrator may create one standard user account, hereinafter User1, and one project manager account, hereinafter Manager2. The administrator then assigns access to all or part of the system to a particular user. It is contemplated that the accounts created may have different authorization levels that govern the ability of a user to make changes, add components or otherwise differentially treat users along any number of parameters.

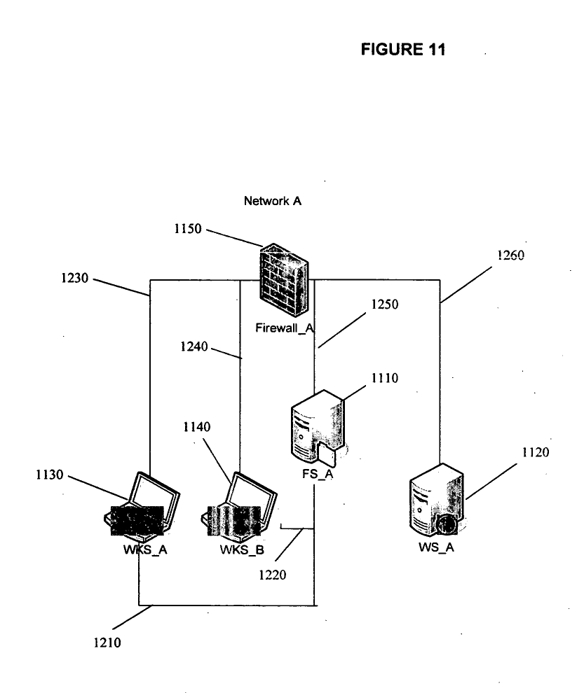

For example and with reference to FIG. 11, the administrator may assign Network A to User1. Prior to employing the methods and steps of the present invention, User1 may require the use of a conceptual overview of the system as a guide to the system. User1 may use a Concept of Operation document (ConOp) and Concept of Operation diagram (ConOp diagram). The ConOp is a document detailing the design of the system to be tested. The ConOp diagram is a design diagram of the system to be tested. FIG. 11 is a simplified and exemplary ConOp diagram. With reference to FIG. 11, the ConOp diagram displays five component groups of the theoretical system: a fileserver “FS_A” 1110, a webserver “WS_A” 1120, a workstation “WKS-A” 1130, a second workstation “WKS_B” 1140, and a firewall “Firewall A” 1150.

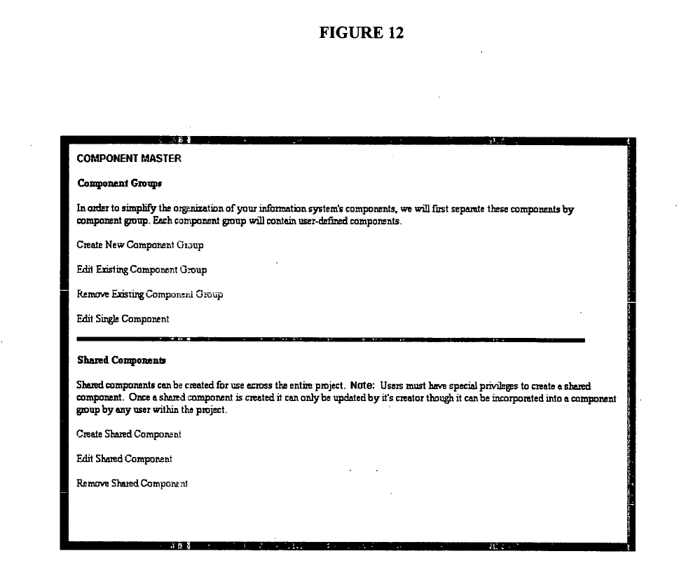

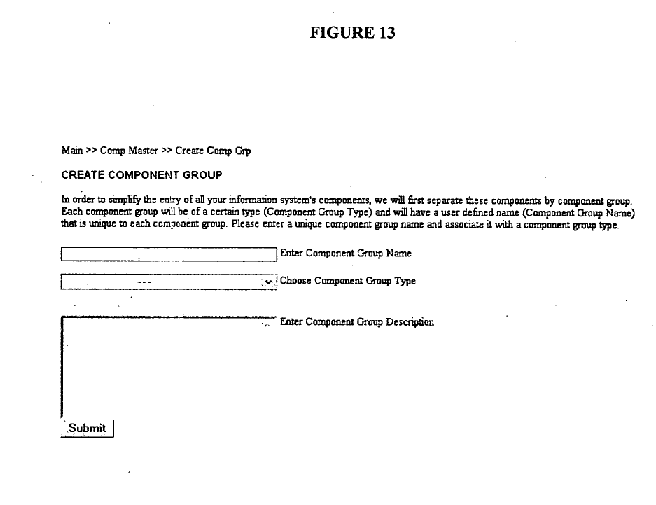

With reference to FIG. 11, User1 may upload the ConOp and ConOp diagram after logging on to the system. Based on the ConOp document and diagram, User1 begins identifying and creating within the system the components of the system to be tested. With reference to FIG. 11, User1 would create five component groups: a fileserver “FS_A” 1110, a webserver “WS_A” 1120, a workstation “WKS-A” 1130, a second workstation “WKS_B” 1140, and a firewall “Firewall A” 1150. To create these component groups User1 begins at the Component Master Screen, a screen display of which is provided as FIG. 12. From the Component Master Screen, User1 would use the Create New Component Group which would take User1 to an interface which would allow User1 to input information relating to the component group, a screen display of said interface is provided as FIG. 13.

After creating the component groups, User1 then creates or enters the components that comprise the component group. In the theoretical system of the current example, the components of the component groups are displayed in the following tables.

| Component Group Name | Components |
|---|---|
| Component Group FS_A | Windows 2000 Server |
| | Internet Explorer Shared |
| | FS_A_Int (Interface component) |

| Component Group Name | Components |
|---|---|
| Component Group WS_A | Apache |
| | Windows 2000 Server |
| | FS_A_Int (Interface component) |

| Component Group Name | Components |
|---|---|
| Component Group WKS_A | Windows XP Shared |
| | Internet Explorer Shared |
| | WKS_A_Int (Interface component) |

| Component Group Name | Components |
|---|---|
| Component Group WKS_B | Windows XP Shared |
| | Internet Explorer Shared |
| | WKS_B_Int (Interface component) |

| Component Group Name | Components |
|---|---|
| Component Group Firewall_A | Firewall Software |
| | Firewall_A_Int (Interface component) |

In creating each of the components, User1 may choose a Component Type. The Component Type selection provides the software with information regarding the component and allows the software to pre-assign requirements as a function of the security policy selected. In addition, User1 has the option to map additional requirements to the identified components or remove the requirements that have been automatically mapped to the identified components. For example, in one of the above component groups, component Windows 2000 of the component group WS-A 1130 was of the “Operating System” type. The software automatically maps the “Power2” requirement to components of the “Operating System” type. User1 will have the option of marking this requirement as “Not Applies.” Any requirements marked as “Not Applies” will not require that a security service meet the requirement for that component. In addition, components that are described as Component Type “<Group Type>-Int” are interface components that, under the system identification parameters of this example, will not have any requirements mapped to the component as these components exist only as an interface between groups. Once all the components of the component groups have been marked as completed, i.e. User1 has made a determination of whether the pre-assigned requirement should remain mapped and whether additional requirements should be mapped to the components, User1 may then move on to the steps of creating paths and mapping requirements to the paths.

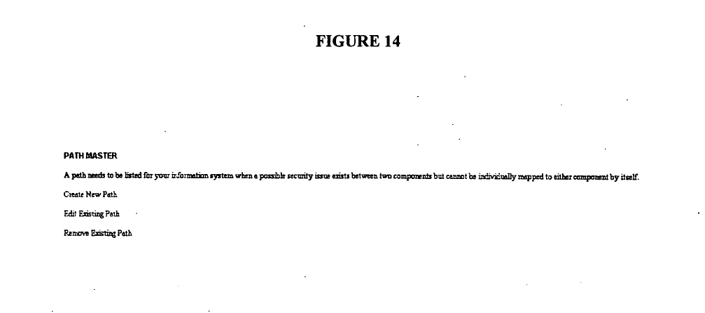

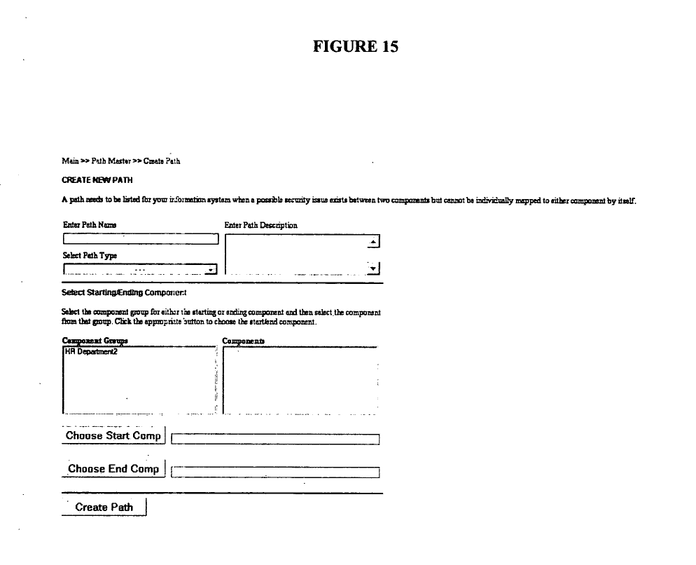

Following the identification and creation of component groups, User1 may then create and map requirements to the system's paths. With reference to FIG. 10, the ConOp diagram indicates that there are six paths User1 will enter: WKS_A to FS_A 1110, WKS_B to FS_A 1120, WKS_A to Firewall_A 1130, WKS_B to Firewall_A 1140, FS_A to Firewall_A 1150, and WS_A to Firewall_A 1160. To create these paths User1 begins at the Path Master Screen a screen display of which is provided as FIG. 14. From the Path Master Screen, User1 would use the Create New Path which would take User1 to an interface which would allow User1 to input information relating to the Path, a screen display of said interface is provided as FIG. 15.

In one embodiment of the invention, User1 may name the created path, provide a description of the path, input the start and end components of the path, and choose a Path Type. As in Component Type, the Path Type designation may automatically map requirements based on the system identification parameters. After entering this information, User1 will then review the mapped requirements, marking as “Not Applies” any requirements User1 wishes to remove and may optionally map additional requirements to the created paths.

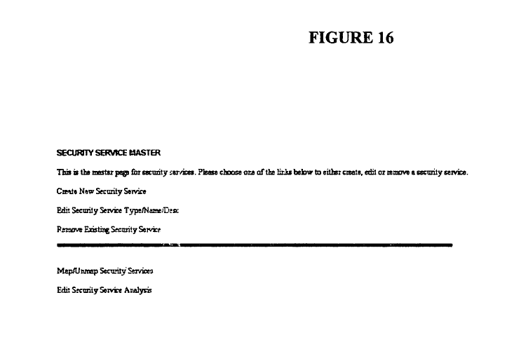

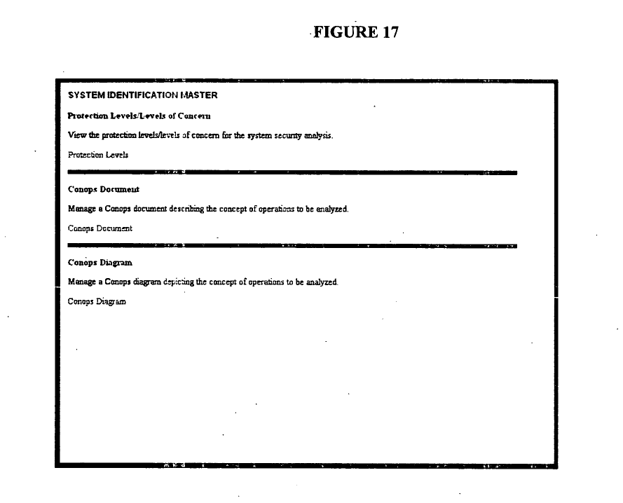

After mapping requirements to the components and paths, User1 will then create the system's security services as described in the workflow diagram of FIG. 5. To create these security services, User1 begins at the Security Service Master Screen a screen display of which is provided as FIG. 16. From the Security Service Master Screen, User1 would use the Create New Security Service which would take User1 to an interface which would allow User1 to input information relating to the Security Service, a screen display of said interface is provided as FIG. 17. In the present example, User1 would create security service Firewall_A. Note that in this example, Firewall_A is both a security service and a component group. It is contemplated in other embodiments that components of a system may also be security services of the system.

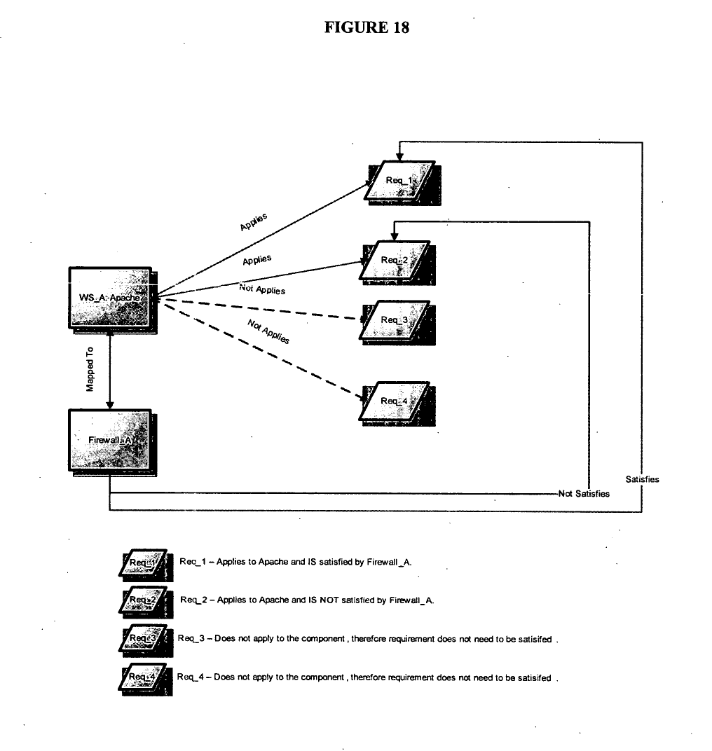

After creating the security service, User1 may then map the security service to each component or path that the security service protects. To do so, User1 would use the Map/Unmap Security Services function of the software residing on the computer to identify the paths and components to which the security service should be mapped (screen display not provided). In the present example, User1 may map the security service Firewall_A to the component WS_A: Apache. The relationship between the security service Firewall_A and the component WS_A: Apache is depicted in FIG. 18. With reference to FIG. 18, security service Firewall_A 1810 is mapped to component WS_A: Apache 1820. Req_1 1830 and Req_2 1840 are shown as mapped to the component WS_A: Apache. Req_3 1850 and Req_4 1860 are shown as “Not Applies” to component WS_A: Apache.

After User1 has created and/or mapped the components, paths, requirements, and security services, an analysis of the system is then performed. The analysis determines whether the security services mapped to the created paths or components satisfy the requirements mapped to the paths or components. In the present example, Req_1 1830 which is mapped to the WS_A: Apache 1820 an said requirement is satisfied by security service Firewall_A 1810. The user would provide a rationale for the determination that the security services Firewall_A 1810 meets the requirement Req_1 1830 which is mapped to component WS_A: Apache 1820 before being allowed to proceed with the analysis. As can be seen in FIG. 18, further analysis of the mapped requirements would indicate whether the requirements mapped to the component are satisfied by the corresponding security services.

After completion of the analysis, User1 is then provided with information relating to the analysis for all components and paths to determine whether the requirements mapped to those components and paths are satisfied. These reports can be used to document the security of the system as well as provide User1 with information relating to the vulnerabilities of the system.

One skilled in the art will recognize that one advantage of the present invention includes the ability to manage, analyze, and/or review a system throughout its lifecylce—from the design and implementation of a system through updates, revisions, additions, and/or modifications to the design of the system. For example, when a new component and/or path is added to the system, the requirements may be mapped and the security services may be associated to those new components and/or paths and an updated security analysis may be readily obtained without conducting a system-wide review. In addition, if requirements and/or security services change, the present invention facilitates the updating, addition, deletion, and/or modification of a system's existing requirements and/or security services and their corresponding associations. In this regard, the present invention advantageously eliminates the need for a system-wide review or analysis of the system. Another feature of the present invention facilitates the secure build and/or design of a system providing a predictive security method eliminating the need for a system-wide security analysis after the completed design, build, and/or modification of a system.

While the invention herein disclosed has been described by means of specific embodiments and applications thereof, numerous modifications and variations can be made thereto by those skilled in the art without departing from the scope of the invention as set forth in the claims.

What is claimed is:

1. A method of performing a security analysis of a system having at least one component and at least one path capable of being identified, each of the at least one components having hardware and/or software and each of the at least one paths interconnected to each of the at least one components, said method comprising the steps of:
identifying components of the system;
mapping at least one predefined requirement with which the system is to comply to at least one of the components of the system;
identifying paths of the system;
mapping at least one predefined requirement with which the system is to comply to at least one of the paths of the system;
selecting at least one security service to be used, each of said security services configured to satisfy at least one of the requirements;
associating the security services to the components of the system;
associating the security services to the paths of the system;
analyzing the associated security services of the system; and
producing a report based on results from the analysis of the system.

2. The method according to claim 1, wherein the steps of identifying components is collected for the system comprising a plurality of components within a network, by at least one of electronic discovery via a network and manual entry.

3. The method of claim 1, wherein the security services selected are intrinsic or extrinsic to the components and paths of the system.

4. The method of claim 1, wherein the requirements are stored in a data repository for access.

5. The method of claim 1, wherein the security services are automatically associated as satisfying at least on or more requirements.

6. The method of claim 1, wherein the step identifying the components of a system is aided by at least one of a design document or design diagram.

7. The method of claim 1, wherein the step identifying the paths of a system is aided by at least one of a design document or design diagram.

8. The method of claim 1, wherein a means is provided to record, document, or store a rationale for the determination that a security service associated to a component or path satisfies one or more requirements mapped to said components or paths.

9. A first computer system for performing a security analysis of a second computer system having at least one component and at least one communication path capable of being identified, each of the at least one components having hardware and/or software and each of the at least one communication paths interconnected to each of the at least one components, the first computer system comprising:
a computer configured to:
identify components of the second computer system;
map at least one predefined requirement with which the second computer system is to comply to at least one of the components of the second computer system;
identify paths of the second computer system;
map at least one predefined requirement with which the second computer system is to comply to at least one of the paths of the second computer system;
select at least one security service to be used, each of said security services configured to satisfy at least one of the requirements;
associate the security services to the components of the second computer system;
associate the security services to the paths of the second computer system;
analyze the associated security services of the second computer system; and
produce a report based on results from the analysis of the second computer system.

10. The system of claim 9, wherein the steps of identifying components of the second computer system is collected for the second computer system comprising a plurality of components within a network, by at least one of electronic discovery via a network and manual entry.

11. The system of claim 9, wherein the security services selected are intrinsic or extrinsic to the components and paths of the second computer system.

12. The system of claim 9, wherein the requirements are stored in a data repository for access.

13. The system of claim 9, wherein the security services are automatically associated as satisfying at least one or more requirements.

14. The system of claim 9, wherein the step identifying the components of a second computer system is aided by at least one of a design document or design diagram.

15. The system of claim 9, wherein the step identifying the paths of a second computer system is aided by at least one of a design document or design diagram.

16. The system of claim 9, wherein a means is provided to record, document, or store a rationale for the determination that a security service mapped to a component or path satisfies one or more requirements mapped to said components or paths.

17. A software program implemented in a first computer system performing a security analysis of a second computer system having at least one component and at least one communication path capable of being identified, each of the at least one components having hardware and/or software and each of the at least one communication paths interconnected to each of the at least one components, the software program configuring the first computer system to:
identify components of the second computer system;
map at least one predefined requirement with which the second computer system is to comply to at least one of the components of the second computer system;
identify paths of the second computer system;
map at least one predefined requirement with which the second computer system is to comply to at least one of the paths of the second computer system;
select at least one security service to be used, each of said security services configured to satisfy at least one of the requirements;
associate the security services to the components of the second computer system;
associate the security services to the paths of the second computer system;
analyze the associated security services of the second computer system; and
produce a report based on results from the analysis of the second computer system.

18. The program of claim 17, wherein the steps of identifying components of the second computer system is collected for the second computer system comprising a plurality of components within a network, by at least one of electronic discovery via a network and manual entry.

19. The program of claim 17, wherein the security services selected are intrinsic or extrinsic to the components and paths of the second computer system.

20. The program of claim 17, wherein the requirements are stored in a data repository for access.

21. The program of claim 17, wherein the security services are automatically associated as satisfying at least one or more requirements.

22. The program of claim 17, wherein the step identifying the components of a second computer system is aided by at least one of a design document or design diagram.

23. The program of claim 17, wherein the step identifying the paths of a second computer system is aided by at least one of a design document or design diagram.

24. The program of claim 17, wherein a means is provided to record, document, or store a rationale for the determination that a security service mapped to a component or path satisfies one or more requirements mapped to said components or paths.
